(19) United States
(12) Patent Application Publication
(10) Pub. No.: US 2005/0177432 A1
(43) Pub. Date: Aug. 11, 2005

(54) Parking system and method

(76) Inventor: John Edward Nevergole, Lafayette Hill, PA (US)

Correspondence Address: Thomas J. McWilliams;REED SMITH LLP, 2500 One Liberty Place, 1650 Market Street, Philadelphia, PA, 19103-7301, US

(21) Appl. No.: 10/743,702

(22) Filed: Dec. 22, 2003

(51) Int. Cl. G06F 17/60

(52) U.S. Cl. 705/16

(57) ABSTRACT

A parking system, and a method of operating a parking system, are disclosed. The parking system includes a central information location including at least one database, at least one client communicatively connected to the central location, and a plurality of alerters, wherein each alerter includes send and receive capabilities. The method includes registering at least one parking location and at least one service provision location with a central location, receiving vehicle information of the vehicle parked in a database at the central location, associating, at the central location, an alerter with the vehicle parked, associating, at the central location, a vehicle return request time for return of the vehicle parked, and returning the vehicle parked in the vehicle request return time, responsively to an activation of the associated alerter.

### CROSS-REFERENCE TO RELATED APPLICATIONS

N/A

### FIELD OF THE INVENTION

The present invention relates to a parking system and method, and, more particularly, to a parking system and method that increases customer convenience, while lowering vehicle loss, damage, and theft, as well as providing improved accounting methodologies for parking systems

### BACKGROUND OF THE INVENTION

Valet parking is frequently available at service provision establishments. In a typical valet embodiment, a valet takes the vehicle, and the keys associated therewith, from a customer of the service provider, and parks the vehicle at a parking location near to, or associated with, that particular service provider establishment. The customer, upon completion of receiving the desired service, then goes to the attendant and asks for the vehicle. The customer must then wait the amount of time it takes the attendant to go, locate the vehicle, start the vehicle, and drive it back to the location at which the customer has waited. Obviously, this can lead to long wait times for a customer requesting the return of a vehicle, particularly in embodiments wherein the vehicle is not parked nearby, such as wherein an immediately adjacent lot has become full, and a spill over lot a further distance must be used.

Thus, current parking embodiments create frustration and wasted time for the customer, a lack of accountability for vehicle damage, loss, or theft, and an inability to track payment made or not made to attendants. Therefore, the need exists for a parking system and method that increases customer convenience, while lowering vehicle loss, damage, and theft, as well as providing improved accounting methodologies for parking systems.

### BRIEF SUMMARY OF THE INVENTION

The present invention includes a parking system. The parking system includes a central information location including at least one database, at least one client communicatively connected to the central location, and a plurality of alerters, wherein each alerter includes send and receive capabilities. Each client communicates via a network with the central location, and at least vehicle information of a vehicle parked and a location of the vehicle parked are entered to the at least one database from at least one client. A vehicle return request time is associated with the vehicle parked by the central location into the at least one database, and the vehicle parked is returned responsively to activation of a one of the alerters uniquely associated with the vehicle parked in the vehicle return request time.

The present invention additionally includes a method of operating a parking system. The method includes registering at least one parking location and at least one service provision location with a central location, upon arrival of a vehicle parked at the service provision location, receiving vehicle information of the vehicle parked, and receiving one of the parking locations for the vehicle parked, in a database at the central location via at least one client connected to the database via a network, uniquely associating, at the central location, an alerter with the vehicle parked in the at least one database, associating, at the central location, a vehicle return request time for return of the vehicle parked, forwarding the vehicle information, the parking location, the alerter association, and the vehicle return request time for vehicle return, to the service provision location, and to the parking location, and returning the vehicle parked in the vehicle request return time, responsively to an activation of the associated alerter.

Thereby, the present invention provides a parking system and method that increases customer convenience, while lowering vehicle loss, damage, and theft, and that improves accounting methodologies for parking systems.

### BRIEF DESCRIPTION OF THE SEVERAL VIEWS OF THE DRAWINGS

The various features of the present invention and its embodiments will now be described in greater detail with reference to the drawings of an embodiment of the present invention, and various related components, wherein like reference numerals designate like elements, and wherein:

FIG. 1 is a block diagram illustrating a parking system in accordance with the present invention; and

FIG. 2 is a flow diagram illustrating a method of operating a parking system in accordance with the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical parking applications, networks and systems. Those of ordinary skill in the art will recognize that other elements are desirable and/or required in order to implement the present invention. But because such elements are well known in the art, and because they do not facilitate a better understanding of the present invention, a discussion of such elements is not provided herein. The disclosure herein is directed to all such variations and modifications to the applications, networks, and systems disclosed herein and as will be known, or apparent, to those skilled in the art.

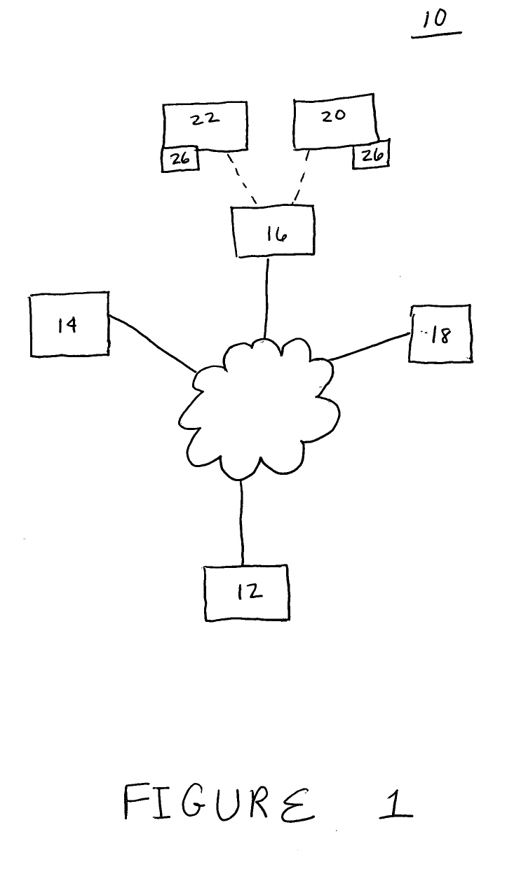

FIG. 1 is a block diagram illustrating a parking system 10 in accordance with the present invention. The parking system includes a central information location 12, and one or more clients 14, 16, 18 communicatively connected to the central location 12. The system further includes a plurality of alerters 20, 22, wherein each alerter may preferably have send and receive capabilities 26.

Each client may be a thin client, having no application resident thereon, but rather communicating via a network with the central location, or an application may be resident on each client. A client may be, for example, a PDA, PC, laptop, portable PC, cellular phone, or the like, and may include any device capable of communicating and processing information.

The central location may be, for example, a remote server, or multiple servers, and may in fact not be centralized, but may be distributed. The central server, in order to perform the tracking discussed herein, preferably has resident thereon one or more databases, such as relational and/or tabular databases, for entry of information and association of information.

The alerter may allow entry of information by the customer via any means known in the art, such as, but not limited to, pressing of button, voice recognition, and the like.

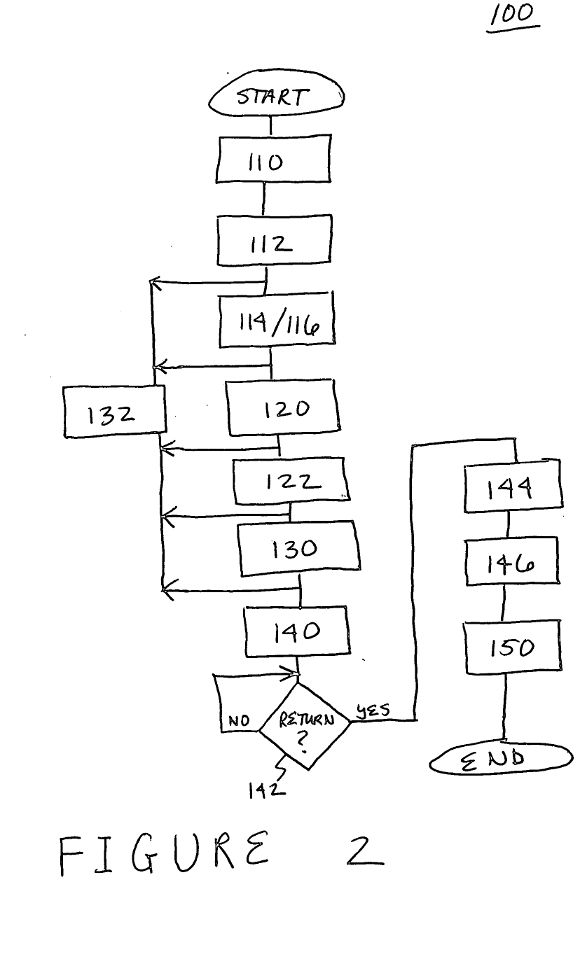

FIG. 2 is a flow diagram illustrating a method 100 of operating a parking system in accordance with the present invention. It will be apparent to those of ordinary skill in the pertinent arts that establishments, locations, parking locations, clients, and the like, in order to use the method and system of the present invention, may be required to register with the central location. Registration 110 may include, for example, purchasing a license, obtaining one or more usernames and passwords for clients, informing the central location of available parking, rental rates for parking, and the like.

As illustrated in FIG. 2, a customer may arrive at an establishment and necessitate parking. The establishment may have thereat, or in association therewith, one or more of the clients. Upon arrival, information regarding the vehicle to be parked may be taken and entered 112 into a client, such as by an attendant, such as a valet. The information may include, for example, an identifying ticket number of a vehicle in accordance with issuance of a numerical ticket stub, wherein the attendant would retain a non-issued portion of the identifying number ticket stub, vehicle information associated with the vehicle, such as license plate or VIN number, a vehicle description and or associated name, such as 2003 Black Acura TL, a scanned vehicle identifier, such as an EZ Pass, VIN number, or bar code, and a location of the establishment at which the customer will receive goods or services.

Upon entry of the information by the attendant to the client, the client may communicate 114 this information to one or more clients resident at and/or within the service provision location, such as by a network, and may additionally send all information to the central location 116 for tracking at the central location. Of note, communications from the attendant to the initial client may be performed by wired connection or wirelessly, such as by entry by the attendant into a wireless PDA, cellular phone, RF device, IR device, or the. Further, for example, communication between clients and the network may be by a wired network connection, such as a telephone line, T1 connection, or the like, or by, for example, a wireless hub or wireless modem. The client to which the attendant enters information, and the client at the service provision location, may be the same client, different clients, multiple clients, or any combination thereof.

Following entry of the customer information to the one or more clients, and communication of this information to other clients and to the central location, the customer may receive an alerter 120, either from the attendant, or from a service provider at the service provision location. The alerter may be, for example, uniquely electronically coded, and the code needed to reach that particular alerter may be associated 122, at the central location, with the information of the vehicle correspondent to the customer receiving that uniquely coded alerter.

The attendant, upon receipt of the vehicle, may be informed 130 by a client of the location to which the vehicle is to be taken, such as by the central location, to later allow for pickup from that location upon a vehicle return request. For example, certain participant parking lots may be full, congested, under construction, closed at particular hours, and the like, and all such information may be tracked at the central location, and the client at a particular geographic location may be informed of the status of available participant lots in that particular geographic location, such as in a particular city, or area of a city. Thus, the attendant may take the vehicle to the predetermined available participant location, and thereby the status and location of all vehicles within the system, at all locations communicating with the system, and of all locations communicating with the system, may be centrally tracked 132. This helps eliminate, for example, vehicle damage and theft by creating a real-time knowledge of vehicle type, ownership, location, and status.

The association of the customer, vehicle, and alerter at the central location may be performed in, for example, one or more databases, such as relational databases and/or tabular databases, resident at the central location. Some, all, or a portion of the customers, alerters, parking locations, and vehicles associated with a particular service provision location may further be available for viewing on a client at that service provision location via request from an authorized user or client. Thus, the authorized service provision location, and the authorization necessary to access the database(s) from that location, may further be associated with each record in the database(s) at the central location.

The customer may be given 140, by the provider of the alerter, a predetermined time frame prior to which the customer is to activate the alerter in order to receive the vehicle. For example, either the attendant or the service provider, upon giving the alerter to the customer, may inform the customer that the alerter is to be activated in a given standard time frame, such as twenty minutes prior to the desired return time of the vehicle. Alternatively, the time frame for return of the vehicle may be variable and tracked at the central location, in accordance with, for example, whether or not parking lots are full, whether spill over parking lots at greater distances must be accessed, the number of attendants available at a given time, the number of attendees then present and parked at the service provision location, those attendees parked at a time proximate to the time the particular customer was parked and who may thus wish to receive vehicles at approximately the same time, and like factors discussed further hereinbelow. Thereby, for each vehicle, the central location may generate a unique predetermined time frame for the return of each vehicle, and, upon entry of the vehicle information or giving of the alerter, the customer may be informed by the attendant or service provider of the unique time frame necessary for return of the vehicle under the present circumstances. For example, customer A may arrive for a meal at a restaurant, and, to the extent parking is available immediately adjacent to the restaurant, the customer may be quoted a return request time frame of 10 minutes prior to desired return. However, a later arriving customer arriving at a busy hour may have the vehicle parked at a spill over lot several miles away, and therefore that customer may receive a return request time frame quote of 30 minutes prior to desired return. The information regarding vehicle return request time frames may preferably be uniquely associated with information on each vehicle at the central location, such as in the database(s). In an additional embodiment, such as wherein the restaurant strictly allows a particular time frame, such as two hour time frames, for eating, or wherein seatings at a particular restaurant occur at particular seating times, the alerter may alert the customer when the vehicle is ready for pickup, such as after the customer has been at the service provision location for one hour and forty-five minutes.

A customer may activate the alerter to engage 142 a return vehicle request. The client at the attendant location may then be informed 144 of the customer request, as may be the client at the service provider location and at the central location. Thereby, a bill for parking may be automatically generated 146 either locally or at the central location, and may, in embodiments wherein the billing system of the service provider is connected to the system of the present invention, cause parking charges to be added directly to service provision billings, for example.

In an embodiment wherein payment is not made at the service provider, or directly to the attendant, for return of the vehicle, or wherein payment is not received in advance, the system of the present invention may associate vehicle information with particular billing aspects, such as wherein an attendant may scan, for example, an RF tag associated with the vehicle, such as an EZ Pass, and wherein scanning of that information automatically causes a charging to the credit card of the owner of the vehicle associated with that RF tag.

Upon receipt of the return request for vehicle, the attendant may additionally receive, such as from the central location, all relevant information associated with the particular alerter that has been activated, including, for example, all vehicle identifying information and the name of the party picking up the vehicle. The attendant may get the correct vehicle 150 from the location that the particular vehicle is parked at, according to the instructions from central location.

In an embodiment, certain parking lot locations within available venues may be associated with the system of the present invention, while others may not be, as alluded to hereinabove. For example, due to increased customer volume likely generated for participating parking locations, parking locations may grant discount rates to service providers willing to park vehicles at that location, and may inform the central location of the discounts to be granted upon registration of that parking location with the central server. Thereby, the increased efficiencies of the present invention may provide cost savings to service providers, and increased revenues to parking locations. As will be apparent to those skilled in the art, methodologies may preferably be resident at the central location that select, for each service provider, preferred and alternative parking locations for each vehicle, and these preferences may be by cost, level of congestion, or the like. These methodologies will, of course, allow for an improved accounting for parking services, both for registered service providers and for registered parking locations.

The central location may track available parking at a multitude of locations associated with the system. For example, a primary parking lot for a particular service provider may have twenty spaces available, and seven other parking lots may additionally be available. Upon filling of the twenty spaces available in the primary lot, the central location may track other available lots associated with the system, and locate the best, or least expensive, location for parking of the vehicle as an alternative to the primary parking location.

In light of the disclosure herein, numerous alternative embodiments will be apparent to those skilled in the art. For example, in an embodiment wherein a vehicle is parked in a parking location immediately proximate to the attendant, vehicle keys may be stored, for example, on a key board. The key board may include one or more activatable items, such as a switch or a light, associated with each keyhook on the key board, and associated with particular alerter codes. Thereby, upon receipt of keys, keys may be hung on the key board, and the associated switch correspondent to the particular alerter given to that customer may be activated. Upon receipt of a request for the vehicle, the central server may associate the request of the particular alerter with the particular indicator on the keyboard, such as to light up that indicator to allow the attendant to know a vehicle has been requested and to go and access the vehicle.

If not otherwise stated herein, it may be assumed that all components and/or processes described heretofore may, if appropriate, be considered to be interchangeable with similar components and/or processes disclosed elsewhere in the specification. It should be appreciated that the systems and methods of the present invention may be configured and conducted as appropriate for any context at hand. The embodiments described hereinabove are to be considered in all respects only as illustrative and not restrictive. All changes which come within the meaning and range of equivalency of the claims hereinbelow are to be embraced within the scope thereof.

1. A parking system, comprising:
a central information location comprising at least one database;
at least one client communicatively connected to the central location; and
a plurality of alerters, wherein each alerter comprises send and receive capabilities;
wherein each client communicates via a network with the central location, and wherein at least vehicle information of a vehicle parked and a location of the vehicle parked are entered to the at least one database from at least one client, and wherein a vehicle return request time is associated with the vehicle parked by the central location into the at least one database, and wherein the vehicle parked is returned responsively to activation of a one of the alerters uniquely associated with the vehicle parked in the vehicle return request time.

2. The parking system of claim 1, wherein each client is selected from the group consisting of a PDA, a PC, a laptop, a portable PC, and a cellular phone.

3. The parking system of claim 1, wherein the central location comprises a remote server.

4. The parking system of claim 1, wherein the central location comprises a distributed server.

5. The parking system of claim 1, wherein the at least one database comprises a relational, tabular databases.

6. A method of operating a parking system, comprising:
registering at least one parking location and at least one service provision location with a central location;
upon arrival of a vehicle parked at the service provision location, receiving vehicle information of the vehicle parked, and receiving one of the parking locations for the vehicle parked, in a database at the central location via at least one client connected to the database via a network;
uniquely associating, at the central location, an alerter with the vehicle parked in the at least one database;
associating, at the central location, a vehicle return request time for return of the vehicle parked;
forwarding the vehicle information, the parking location, the alerter association, and the vehicle return request time for vehicle return, to the service provision location, and to the parking location; and
returning the vehicle parked in the vehicle request return time, responsively to an activation of the associated alerter.

7. The method of claim 6, wherein the vehicle information comprises at least one selected from the group consisting of an identifying ticket number, a license plate, a VIN number, a vehicle description, a vehicle name, and a scanned vehicle identifier.

8. The method of claim 6, further comprising uniquely electronically coding each alerter, wherein said uniquely associating comprises associated the unique electronic code with the vehicle information.

9. The method of claim 6, wherein said receiving of the parking location comprises varying the parking location in accordance with at least one of a geographic location of the service provision location, congestion of registered ones of the parking locations, closing times of registered ones of the parking locations.

10. The method of claim 6, further comprising tracking all of the vehicles parked, and all of the parking locations, at the central location.

11. The method of claim 6, wherein said registering comprises issuing a username and password for a client at the service provision location.

12. The method of claim 6, further comprising generating a bill for the vehicle parked in accordance with the activation of the associated alerter.

13. The method of claim 12, wherein said generating comprises adding parking charges to billings from the service provision location.

14. The method of claim 12, wherein said generating comprises scanning and automatically billing a payment associated with the vehicle information.
